(19) United States
(12) Patent Application Publication
(10) Pub. No.: US 2016/0214818 A1
(43) Pub. Date: Jul. 28, 2016

(54) Medical examination paper roll having printed message and/or perforations

(71) Applicant: Steve Kohn, Short Hills, NJ (US)

(72) Inventor: Steve Kohn, Short Hills, NJ (US)

(21) Appl. No.: 14/757,074

(22) Filed: Nov. 13, 2015

Related U.S. Application Data
(63) Continuation-in-part of application No. 14/544,634, filed on Jan. 26, 2015.

(51) Int. Cl. B65H 18/28; G09F 23/10; D21H 19/00; B65D 75/00; D21H 27/26; D21H 21/36

(52) U.S. Cl. CPC B65H 18/28; D21H 5/0085; D21H 5/22; D21H 19/00; B65D 75/002; G09F 23/10; B65H 2701/1924

(57) ABSTRACT

A medical examination roll of paper that has perforations so that the paper is easily torn and/or printed information, such as, advertising or games that are printed on one or both sides of the perforations that are located on the medical examination paper.

### RELATED APPLICATIONS

The present application is a continuation-in-part of application Ser. No. which 14/544,634 filed Jan. 26, 2015 which claims priority to provisional patent application No. 61/965,322 filed Jan. 27, 2014.

### FIELD OF THE INVENTION

The present invention relates to medical examination paper rolls that have a printed message on the paper and/or has perforations.

### BACKGROUND OF THE INVENTION

U.S. Pat. No. 7,341,195 relates to a system and method for targeted education and advertising that includes sanitary paper comprising a plurality of portions and a consumer-friendly message disposed on at least one of the plurality of portions. The message preferably comprises health related advertising information. A url is preferably disposed on one of the plurality of portions.

U.S. Pat. No. 8,268,105 relates to a method and apparatus for producing examination table paper rolls that are obtained from a tape of embossed paper, having two layers joined together. The band is obtained from two continuous webs subjected to subsequent steps of embossing, glue application, coupling and stabilization. The method includes applying measured quantities of a sanitizing and/or disinfectant substance between the two layers of embossed paper before their joining.

### SUMMARY OF THE INVENTION

The present invention relates to medical examination paper that has a printed message on the paper and/or has perforations. It is an object of the present invent for the medical examination paper to be in a roll form. It is an object of the present invention for the roll to not have a cardboard core.

It is an object of the present invention for the medical examination roll of paper to be shrink wrapped. It is an object of the present invention to put marketing collateral under the shrink wrap and above the roll or on top the shrink wrapped roll.

It is an object of the present invention for the roll of medical examination paper to have perforations so that the paper can be torn easily. It is an object of the present invention for the perforations to be located at the same precise distance throughout the roll, for example at 6 foot integrals.

It is an object of the present invention to have advertising or games located on both sides of the perforations that are located on the medical examination paper, and no advertising located beyond those locations. This way when a user is sitting on the medical examination paper, they are not sitting on the advertising, but can read or interact with the advertising or games while they are sitting on the medical examination paper.

It is an object of the present invention that when the user is waiting in the examination room they can interact with the examination paper. It is an object of the present invention for the exam paper to have product or service information, advertising, corporate logo, contact information and/or coupons. It is an object of the present information for the coupons to have a bar codes that can be transferred to a mobile device such as a mobile phone. It is an object of the present invention for the coupons to be torn off the paper.

It is an object of the present invention to place an adhesive or other material where the perforations are located on the underside of the medical examination paper, so that the paper can be attached to the table when the paper is placed on the table. In this way the paper does not move while the user is sitting on the paper, or when the paper is placed on the table.

It is an object of the present invention to coat or impregnate the paper with an anti-fungal and/or anti-microbial agent for protecting the patient from possible contamination caused by unchanged medical examination paper.

It is an object of the present invention for the agent to be used in a concentration so as to act as an anti-fungal and/or anti-microbial agent.

It is an object of the present invention for the anti-fungal and anti-microbial agents to be copper (II) 8-quinolinolate (CAS No. 10380-28-6); zinc oxide (CAS No. 1314-13-2); zinc-dimethyl dithiocarbamate (CAS No. 137-304); 2-mercaptobenzothiazole, zinc salt (CAS No. 155-04-4); barium metaborate (CAS No. 13701-59-2); tributyl tin benzoate (CAS No. 4342-36-3); bis tributyl tin salicylate (CAS No. 22330-14-9); tributyl tin oxide (CAS No. 56-35-9); parabens: ethyl parahydroxybenzoate (CAS No. 120-47-8); propyl parahydroxybenzoate (CAS No. 94-13-3); methyl parahydroxybenzoate (CAS No. 99-76-3); and butyl parahydroxybenzoate (CAS No. 94-26-8); methylenebis(thiocyanate) (CAS No. 6317-18-6); 1,2-benzisothiazoline-3-one (CAS No. 2634-33-5); 2-mercaptobenzo-thiazole (CAS No. 149-30-4); 5-chloro-2-methyl-3 (2H)-isothiazolone (CAS No. 57373-19-0); 2-methyl-3(2H)-isothiazolone (CAS No. 57373-20-3); zinc 2-pyridinethiol-N-oxide (CAS No. 1346341-7); tetra-hydro-3,5-di-methyl-2H-1,3,5-thiadiazine-2-thione (CAS No. 533-74-4); N-trichloromethyl-thio-4-cyclohexene-1,2-dicarboximide (CAS No. 133-06-2); 2-n-octyl-4-isothiazoline-3-one (CAS No.26530-20-1); 2,4,5,6-tetrachloro-isophtalonitrile (CAS No. 1897-45-6); 3-iodo-2-propynyl butylcarbamate (CAS No. 55406-53-6); diiodomethyl-p-tolylsulfone (CAS No. 20018-09-1); N-(trichloromethyl-thio)phthalimide (CAS No. 133-07-3); potassium N-hydroxy-methyl-N-methyl-dithiocarbamate (CAS No. 51026-28-9); sodium 2-pyridinethiol-1-oxide (CAS No. 15922-78-8); 2-(thiocyanomethylthio) benzothiazole (CAS No. 21564-17-0); 2-4(-thiazolyl)benzimidazole (CAS No. 148-79-8).

It is an object of the present for the anti-microbial agents and/or anti-fungal agents to be placed on the examination paper.

### BRIEF DESCRIPTION OF THE DRAWINGS

FIG. 1 is a side view of an embodiment of a medical examination paper roll of the present invention.

FIG. 2 is an edge view of an embodiment of a medical examination paper roll of the present invention without any device in the center of the roll.

FIG. 3 is an edge view of an embodiment of a medical examination paper roll of the present invention without any device in the center of the roll.

FIG. 4 is a top view of an embodiment of the medical examination paper of the present invention on the examination table.

FIG. 5 is a top view of an embodiment of the medical examination paper of the present invention.

FIG. 6 is a top view of an embodiment of the medical examination paper of the present invention on the examination table.

### DETAILED DESCRIPTION OF THE INVENTION

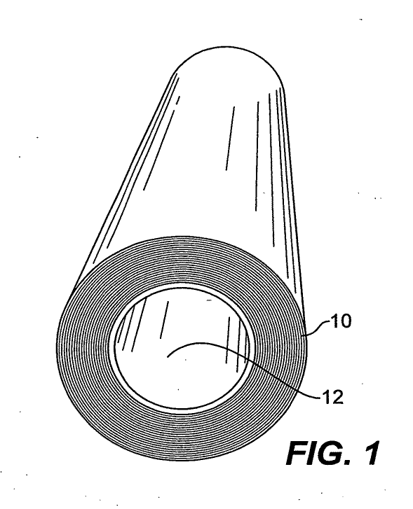

FIG. 1 is a medical examination paper roll comprising the medical examination paper 10 wound around a cardboard roll 12.

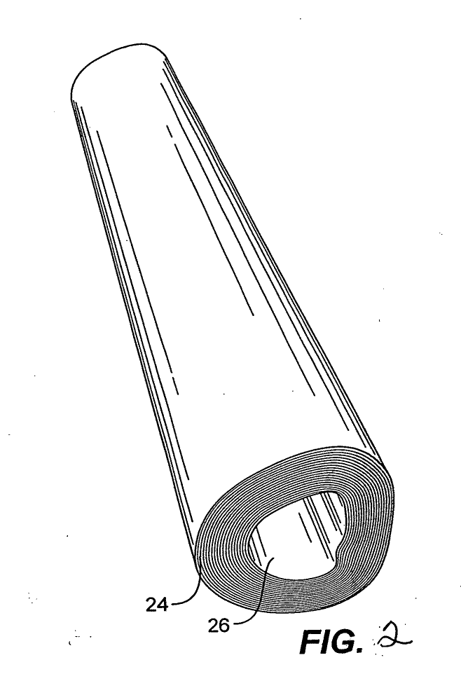

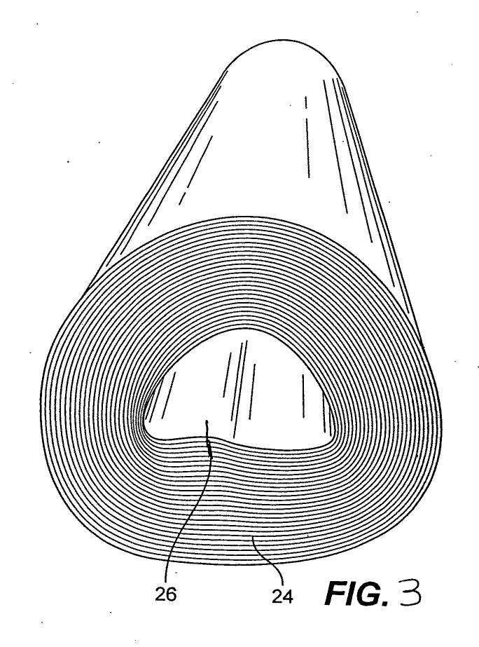

FIGS. 2 and 3 show that the paper roll 24 is deforming inside the diameter 26.

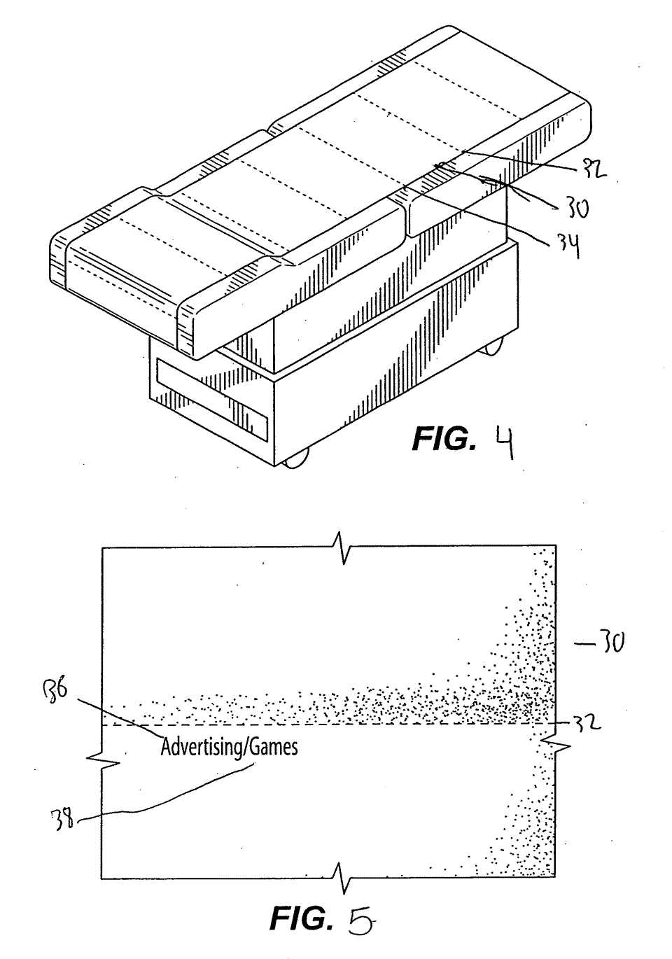

FIGS. 4 and 5 show medical examination paper 30 having perforations 32 and 34, also having games or advertisements 36 and 38.

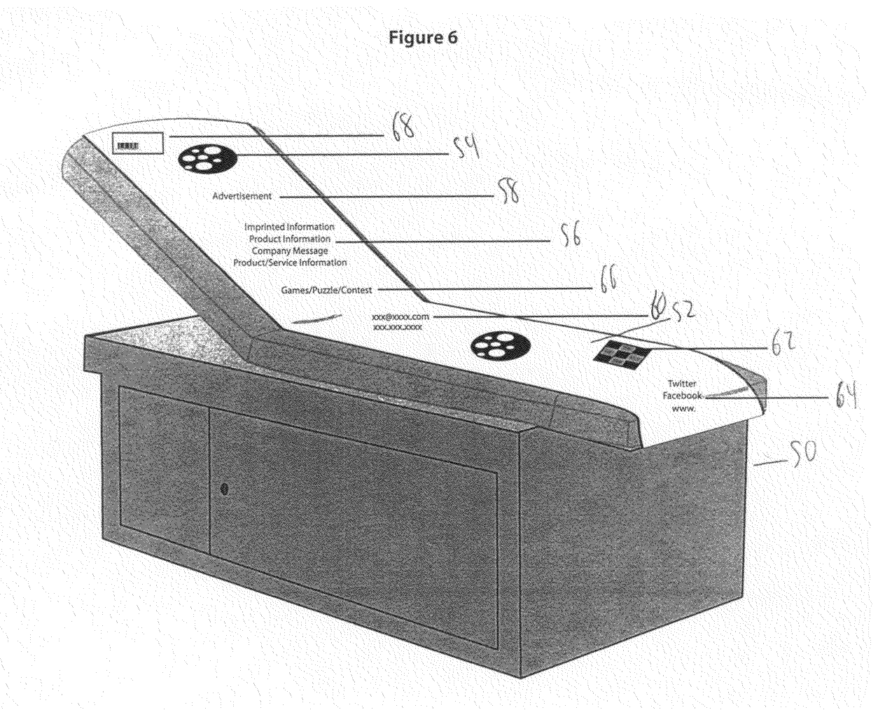

FIG. 6 shows a medical examination table 50 having medical examination paper 52. The medical examination paper has a logo 54, product and service information 56, advertisement 58, contact information 60, 62 and 64, games, puzzles and contests 66 and coupon 68.

In an embodiment, the roll of medical examination paper has perforations so that the paper can be torn easily. In an embodiment, the perforations are located at the same precise distance throughout the roll, for example at 6 foot integrals.

In an embodiment, advertising or games located on both sides of the perforations that are located on the medical examination paper, and no advertising or games are located beyond those locations. This way when a user sits on the medical examination paper, they are not sitting on the advertising or games, but can read or interact with the advertising or games while they are sitting on the medical examination paper.

In an embodiment, an adhesive or other product is placed where the perforations are located on the underside of the medical examination paper, so that the paper can be attached to the table when the paper is placed on the table. In this way the paper does not move while the user is sitting on the paper, or when the paper is placed on the table.

In an embodiment, the medical examination paper is coated or impregnated with an anti-fungal and/or anti-microbial product for protecting the patient from possible contamination from unchanged medical examination paper.

In an embodiment, the anti-microbial/anti-fungal properties are derived from natural compounds that are extracted from plants. In an embodiment, the plants are lusianthrin and chrysin. In an embodiment, the compounds are chemical in nature.

1. A medical examination paper roll comprising:
a roll of medical examination paper;
said medical examination paper having perforations so that said paper is easily torn.

2. The medical examination paper roll of claim 1 wherein said perforations are located at same precise distance on said medical examination paper throughout said roll.

3. The medical examination paper roll of claim 2 wherein said perforations in said paper are located at about six foot integrals.

4. The medical examination paper of claim 1 further comprising, advertising, information or games printed on said medical examination paper.

5. The medical examination paper roll of claim 1 wherein advertising, information or games are printed on both sides of said perforations of said medical examination paper.

6. The medical examination paper roll of claim 5 wherein said advertising or games are only located on both sides of said perforations.

7. The medical examination paper roll of claim 1 wherein an adhesive or other material is placed where said perforations are located on underside of said medical examination paper for holding said medical examination paper against a medical table.

8. The medical examination paper roll of claim 1 wherein said examination paper is coated or impregnated with an agent that is sufficient in concentration to act as an anti-fungal and/or anti-microbial product for protecting a patient from possible contamination from said unchanged medical examination paper.

9. The medical examination paper roll of claim 1 wherein said roll of medical examination paper is shrink wrapped.

10. The medical examination paper of claim 8 further comprising marketing collateral placed under said shrink wrap and above said medical examination paper.

11. The medical examination paper of claim 1 wherein said medical examination paper comprises product or service information, advertising, corporate logo, contact information or coupons.

12. The medical examination paper of claim 11 wherein said coupon has a barcode that is transferred to a mobile device.

13. The medical examination paper of claim 11 wherein said coupon is torn off said medical examination paper.
